(19) United States
(12) Patent Application Publication
(10) Pub. No.: US 2015/0274083 A1
(43) Pub. Date: Oct. 1, 2015

(54) ROOF RACK ASSEMBLY FOR A MOTOR VEHICLE

(71) Applicant: AUDI AG, 85045 Ingolstadt (DE)

(72) Inventor: Robert-Johann Günthner, Gaimersheim (DE)

(73) Assignee: AUDI AG, 85045 Ingolstadt (DE)

(21) Appl. No.: 14/416,973

(22) PCT Filed: Mar. 27, 2013
(86) PCT No.: PCT/EP2013/000913

§ 371 Date: Jan. 23, 2015

(30) Foreign Application Priority Data
Jul. 25, 2012 (DE) 10 2012 014 703.1

(51) Int. Cl. B60R 9/058

(52) U.S. Cl. CPC B60R 9/058

(57) ABSTRACT

A roof rack assembly for a motor vehicle includes a roof railing that can be fastened to a vehicle roof of the motor vehicle, and a load carrier that can be mounted to the roof railing. The load carrier is provided with at least one fastening device which after installation of the load carrier encompasses the roof railing on both sides, at least in sections, and which is provided with a latching projection, which after installation engages through a passage with a latching recess of the roof railing. A covering is provided, by way of which the passage can be closed when the load carrier is in an unmounted state, and a detecting device is provided, by way of which a covered state of the passage can be detected.

The invention relates to a roof rack assembly for a motor vehicle with a roof rack fastenable on a roof of the motor vehicle and a load carrier mountable on the roof rack, wherein the load carrier has at least one fastening device which after mounting of the load carrier at least partially engages around the roof rack on both sides and which has a latching protrusion which after the mounting engages in a latching recess of the roof rack through a passage.

Roof rack assemblies of the aforementioned type are known from the state of the art. They consist of a roof rack which has at least one, often however multiple, for example two, roof rails which are fastenable parallel to each other, for example in longitudinal direction of the motor vehicle, on the roof of the motor vehicle. After being initially fastened, the roof rack usually remains permanently on the vehicle roof. The fastening of the roof rack or the roof rail is accomplished for example in that at least one fastening element traverses the roof panel on which the roof rack at least partially rests, and is connected on its other side with a counter element and/or a roof scaffold of the motor vehicle. The roof rail of the roof rack is preferably at least partially spaced apart from the vehicle roof, i.e., it has for example two roof rail feet with which it contacts the vehicle roof. The roof rail is for example bent so that its two end regions form the roof rail feet while a region of the roof rail between the roof rail feet is spaced apart from the vehicle roof.

The roof rack assembly further includes the load carrier, which is mountable on the roof rack. This means that the load carrier does not have to be permanently present on the roof rack but is only arranged when loads are intended to be transported with the motor vehicle. Correspondingly the load carrier is fastened on the roof rack so as to be manually releasable by a user of the roof rack assembly. In order to satisfy demands on driving dynamics and safety it can be provided that a control device of the motor vehicle is already operated in a different operating mode when the load carrier is mounted than when the load carrier is not mounted, i.e., independent on whether the load carrier is loaded up or not. Hereby the first operating mode takes for example a potential roof load represented by the load carrier into account or a load arranged on or at the load carrier. For this the load carrier for example triggers a switching device when mounted so that its presence can be detected. However, conventional load carriers may also be mounted at locations at which the switching device cannot detect the presence of the load carrier. It may also be the case that the load carrier is unable to cooperate with the switching device, in particular when a load carrier is used that is not approved for the motor vehicle. Thus there is a risk that when improperly fastening the load carrier or the entire roof rack assembly, the control device and with this the motor vehicle are operated in the incorrect operating mode.

It is therefore an object of the invention to set forth a roof rack assembly for a motor vehicle, which does not have the aforementioned disadvantage but ensures on one hand a safe fastening of the load carrier on the roof rack and on the other hand a reliable recognition of the load carrier. In addition the roof rack assembly is to have a pleasing aesthetic.

According to the invention this is achieved with a roof rack assembly with the features of claim 1. Hereby a cover with which the passage can be closed in the non mounted state of the load carrier is provided, and a detection device with which a covered state of the passage can be detected. The holding of the load carrier on the roof rack after the load carrier is mounted is achieved by means of the fastening device. When the load carrier is mounted it is usually at least partially placed onto the roof rack so that forces can be introduced in vertical direction from the load carrier into the roof rack and via the roof rack into the vehicle roof. The introduction of forces can be provided on multiple sites or exclusively via the fastening device. In order to also achieve a fastening in lateral direction, the fastening device engages after the mounting at least sections of the railing on both sides. Hereby it is in particular provided that the fastening device engages around each of the roof racks on both sides so that the fastening device immediately borders on each of the roof rails and is supported on it. The engagement of the fastening device around the roof rack on both sides means that the fastening device is present on a first side and on a second side opposite the first side so that the roof rack or the roof rail is held by the fastening device at least in lateral direction, i.e., transversely to a longitudinal direction as well as in a vertical direction of the motor vehicle.

An unintended lifting of the load carrier in the vertical direction from the roof rack after mounting is usually sought to be prevented by a latching connection or rear grip connection. For this purpose the latching protrusion is provided on the load carrier or on the fastening device, which latching protrusion after the mounting is present at least on one side of the roof rack or at least one of the roof rails. Preferably at least one such fastening protrusion is assigned to each roof rail. The roof rack or the roof rail has at least one latching recess with an outwardly facing through opening. When the load carrier is mounted the latching protrusion of the load carrier can thus extend through the passage so that it enters into the latching recess and is situated in the latching recess after mounting. When the latching protrusion is at least partially arranged in the latching recess, the latching connection or the rear grip connection between the load carrier and the roof rack is formed so that the load carrier can no longer be removed from the roof rack in vertical direction.

In order to achieve a pleasing aesthetic of the roof rack assembly, the cover is provided. The cover closes the passage and thus covers the latching recess so long as the latching protrusion does not engage in it, i.e., in the non mounted state of the load carrier. The presence of the load carrier on the roof rack can also be reliably recognized by means of the cover. For this purpose the detection device is provided with which the covered state of the passage can be detected, i.e., whether the cover closes the passage or whether it is displaced by the mounting and the associated engagement of the latching protrusion into the latching recess, so that the passage is at least partially released. It is particularly advantageous when the cover closes the passage fully in the non mounted state of the load carrier, i.e., when it fully covers the latching recess.

When multiple roof rails are present, multiple latching recesses are particularly advantageously provided on sides of the roof rails that face away from each other, i.e., in particular respectively outwardly-facing in lateral direction relative to the motor vehicle. Relative to the roof rack or the roof rail a fastening mount for a fastening means can be provided opposite the latching recess, with which the load carrier can be additionally fastened on the roof rack. The fastening means and the fastening mount can for example be configured as threaded bolt and associated threaded bore or associated threaded insert. Such a configuration results in a very high safety of the roof rack assembly because it is always reliably held on the vehicle in all driving situations.

By means of the detection device it can be reliably determined whether the load carrier is present on the roof rack. For this purpose not the presence of the load carrier itself but rather the position of the cover relative to the latching recess or the passage is determined. This is because mounting of the load carrier on the roof rack strictly requires that the cover is at least partially opened for releasing the passage. There are thus two clearly identifiable states which are preferably detected in a contactless manner and can be subsequently communicated to the control device. When the passage is at least partially closed by the cover, in particular fully closed, the load carrier is certainly not mounted on the roof rack. When on the other hand the passage is not closed by the cover, in particular fully released, the presence of the load carrier on the roof rack is recognized.

A refinement of the invention provides that the cover is configured as a flap and is supported pivotal on the roof rack. The cover is thus securely held relative to the roof rack. For this purpose it is constructed as a flap which is fastened pivotal about a pivot axis for example on the roof rack.

A refinement of the invention provides that the detection device has at least one magnet and at least one magnetic field sensor. This enables a very simple and low-wear configuration of the detection device because the magnet and the magnetic field sensor usually do not include any movable elements. The magnetic field sensor—which can also be referred to as magnetometer—is for example configured as Hall-sensor, XMR sensor or the like. The magnet and the magnetic field sensor are arranged relative to each other so as to assume different positions relative to each other in response to the displacement of the cover relative to the passage for closing or releasing the passage. For example the magnet is arranged closer to the magnetic field sensor when the cover is arranged for closing the passage (closed position) than when the passage is released (open position) or vice versa. By means of the magnetic field sensor it can now be determined whether the magnet is located in proximity to the magnetic field sensor and correspondingly conclusions can be drawn regarding the arrangement of the cover relative to the passage.

A refinement of the invention provides that the magnet is fastened on the cover and the magnetic field sensor is fastened on the roof rack. In such an embodiment the magnet and the magnetic field sensor are displaceable relative to each other. Of course the opposite arrangement can also be selected in which the magnet is provided on the roof rack and the magnetic field sensor on the cover.

A refinement of the invention provides that the cover is at least partially received in the latching recess after the mounting. Prior to the mounting the cover closes the passage which itself is not a part of the latching recess but is rather situated between the latching recess and an outer environment of the roof rack assembly. Insofar the cover does not engage in the latching recess prior to the mounting. During the mounting the latching protrusion is then displaced into the latching recess, thereby also urging the cover into the latching recess. Correspondingly after the mounting the cover is situated to a larger degree in the latching recess than prior to the mounting. In other words the cover is arranged closer to a rear wall of the latching recess after the mounting than in the non mounted state of the load carrier. Preferably the cover is configured elastic or is at least impinged with a spring force, for example by a corresponding bearing support on the roof rack or by being configured at least partially elastic, which in the non mounted state of the load carrier causes it to be urged out of the latching recess in the direction of its starting position. In particular the spring force causes a displacement of the cover so that the passage is closed again, in particular completely, after completed displacement.

A refinement of the invention provides that the cover and the passage extend at least over the latching recess and a support recess adjacent the latching recess, wherein the cover rests against a support element in the support recess so that it is supported in the passage. Beside the latching recess at least one support recess is provided. In particular such a support recess is provided on each side of the latching recess—viewed in longitudinal direction. For example a passage is assigned to the latching recess and the support recess or each of the support recesses, which passage can also be configured as a single continuous passage, i.e., extending over all latching recesses and support recesses of the roof rail arranged on the same side or adjacent each other.

The latching recess as well as the support recess are thus accessible through the passage from outside the roof rack assembly. The cover extends over the latching recess as well as the support recess so that they cannot be seen from the outside. Such a continuous cover significantly improves the aesthetic appearance of the roof rack assembly. Of course the cover can alternatively also be configured from multiple parts. Particularly preferred however is a single, continuous cover which closes the latching recess as well as the support recess and the passage or the respective passage, in particular completely. It is provided that the cover is only displaceable in the region of the latching recess in such a manner that the latching protrusion can traverse the passage. In the region of the support recess this is prevented by the support element against which the cover rests so that the cover cannot be displaced into the support recess for releasing the passage. Correspondingly it is at least supported or held in the direction of the support recess in the passage.

A refinement of the invention provides that the latching recess and the support recess are configured continuous. This enables a particularly simple production of the roof rack assembly or the roof rack. In this case the latching recess and the support recess merely represent regions of the same recess which is configured continuous. In this case the latching recess and the support recess for example have substantially the same cross section and seamlessly transition into each other.

A refinement of the invention provides that the cover in the region of the latching recess is operatively connected with a pushrod which is guided in a rear wall of the latching recess in an interior space of the roof rack. Also in the region of the latching recess the cover thus rests against an element. In contrast to the support recess this is however not a support element fixed in position which is preferably fastened on the rear wall of the recess or the support recess. Rather, the pushrod is provided which is displaceable in its axial direction and to this end is in particular supported in the rear wall. Via the pushrod the afore-described spring force can for example be exerted onto the cover so that in the non mounted state of the load carrier the cover is returned to its starting position. A spring element can engage on the side of the push rod which faces away from the cover.

A refinement of the invention provides that on the side of the pushrod facing away from the cover the pushrod interacts with the detection device. Correspondingly the position of the pushrod relative to the rear wall indicates the covered state of the passage.

A refinement of the invention provides that the roof rack is an extruded section. Such an embodiment can be particularly advantageously realized when the latching recess and the support recess are configured continuous and—as described above—have the same cross section. After producing the roof rack as extruded section, the support element can for example be arranged in the region of the support recess and/or the recess can be introduced into the rear wall of the latching recess.

In the following, the invention is described by way of the exemplary embodiments shown in the drawing, without limiting the invention. It is shown in:

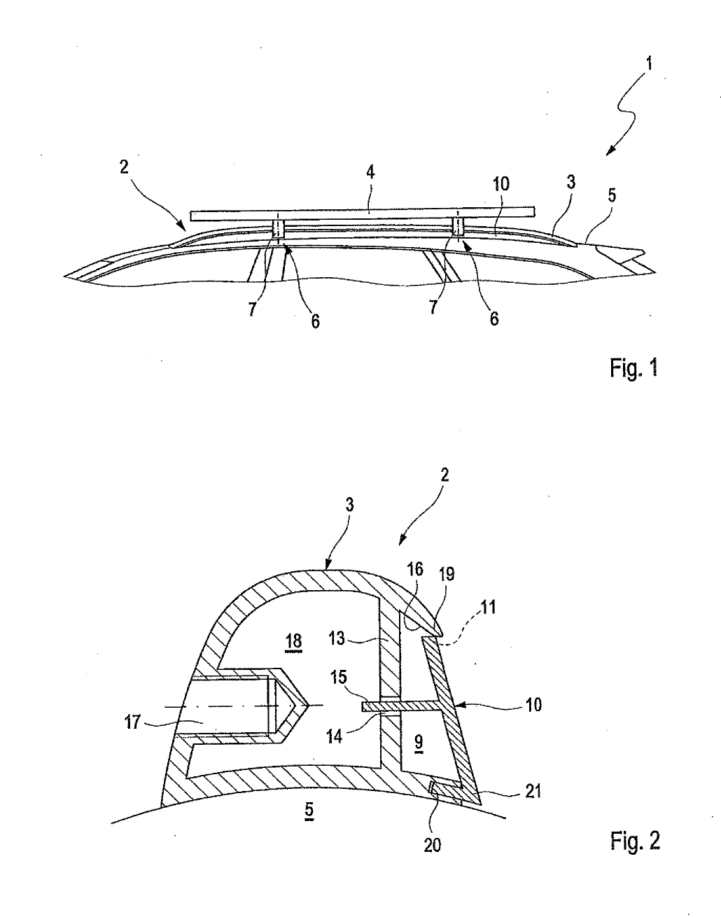

FIG. 1 a side view of a roof rack assembly with a roof rack fastenable on a vehicle roof, and a load carrier mountable on the roof rack,

FIG. 2 a longitudinal section through the roof rack in the region of a latching recess in a non mounted state of the load carrier,

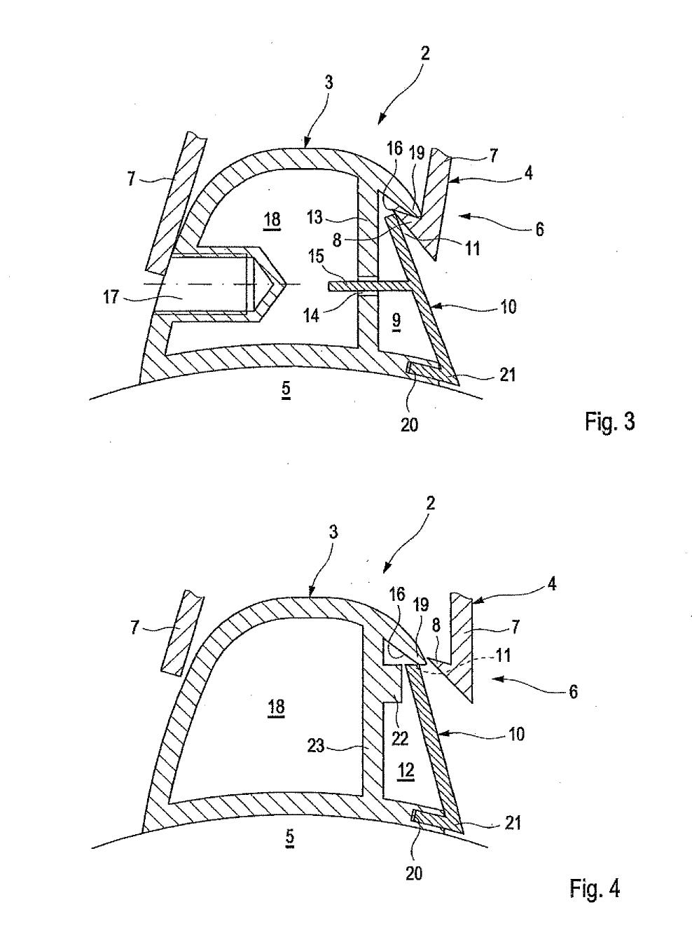

FIG. 3 A longitudinal section through the roof rack in the region of the latching recess in a mounted state of the load carrier, and

FIG. 4 a longitudinal section through the roof rack in the region of a support recess in which a support element is arranged.

FIG. 1 shows a side view of a roof rack assembly 1 for a motor vehicle. The roof rack assembly 1 is formed by a roof rack 2 with at least one roof rail 3 and a here only schematically shown load carrier 4, the roof rack 2 is fastenable or is fastened on a vehicle roof 5. The roof rail 3 assigned to the roof rack 2 rests for example on the vehicle roof 5 over its entire length. However, it can also be provided that it is only in contact with the vehicle roof via at least two roof rail feet. The roof rail feet are for example arranged on free ends of the roof rail 3. Between the roof rail feet the roof rail 3 can be spaced apart from the vehicle roof 5. In the present embodiment the roof rail 3 rests on the vehicle roof 5 along its entire length. Preferably the roof rack 2 is permanently fastened on the vehicle roof 5 while the load carrier 4 is only mounted on the roof rack 2 when needed. For example two roof rails 3 are present, which are arranged parallel to each other and extend over the vehicle roof 5 in longitudinal direction of the motor vehicle.

The load carrier 4 is preferably suited for directly receiving loads or is at least connected or connectable with a corresponding receptacle. It is for example formed by at least one transverse beam which can be arranged on the roof rail 3 or the roof rails 3. in the latter case the transverse beam thus extends from a first one of the roof rails 3 to a second one. wherein these are spaced apart from each other. the load carrier 4 has at least one fastening device 6, wherein in the present embodiment two respective fastening devices 6 are provided for each roof rail 3. each fastening device 6 has two holding arms 7, wherein these are arranged pair wise so that they engage around the roof rail 3 on both sides after the mounting of the load carrier 4. this means that one of the holding arms 7 is arranged in lateral direction on one side adjacent the roof rail 3 and a further one of the holding arms 7 on the opposite side of the roof rail 3, so that rail 3 is held form fittingly and/or is clamped between them in lateral direction. each of the fastening devices 6 thus engages around at least a section of the roof railing or at least one of the roof rails 3 on both sides.

Thereby a here not visible latching protrusion 8 engages in a here also not visible latching recess 9. this latching recess 9 is closed by the cover 10 in the non mounted state of the load carrier 4. The cover 10 is present in a passage 11 (here not visible), which connects the latching recess 9 with an outer environment of the roof rack assembly 1. during the mounting the latching protrusion 8 engages through the passage 11 into the latching recess and is subsequently latchingly held in the latching recess 9 so that at least a lifting of the load carrier 4 in vertical direction is prevented by a form fitting connection. Situated between the latching recesses 9 is a here not visible support recess 12, which—viewed in cross section—almost have the same inner contour. The latching recesses 9 and the support recess 12 can be configured continuous, so that the support recess 12 thus extends form a first one of the latching recesses 9 to a second one of the latching recesses 9 and connects these with each other. The cover 10 is configured so that it covers the latching recesses 9 as well as the support recess 12.

FIG. 2 shows a cross section of the roof rack 2 or one of the roof rails 3 in the region of the latching recess 9 for a non mounted state of the load carrier 4 (here not shown). It can be seen that in this non mounted state of the load carrier 4 the cover 10 completely closes the passage 11 so that the latching recess 9 is thus not visible from outside or from an outer environment of the roof rack assembly 1. Rather the latching recess 9 is completely covered by the cover 10. Opposite the cover 10 the latching recess 9 has a rear wall 13, which is provided with a recess 14. In this recess 14 a pushrod 15 is supported so as to be longitudinally displaceable. On one of its ends the pushrod 15 engages on the cover 10. For example a spring force acts on the pushrod 15 which urges the cover 10 into its position shown in FIG. 2, in which it completely closes the passage 11 and thereby for example rests against an end stop 16 formed by the roof rail 3. On the side of the roof rail 3 opposite the latching recess 9 a fastening mount 17 for a fastening element (not shown) of the load carrier 4 can be provided. The fastening element is for example a bolt, while the fastening mounting 17 has a corresponding inner threading so that the bolt can be threadably engaged in the fastening mounting. The fastening means and the fastening mount 14 thus enable an additional fastening of the load carrier 4 on the roof rail 3 or the roof rack 2.

FIG. 3 shows a cross section through the roof rack 2 in the region of the latching recess 9 for a mounted state of the load carrier 4. A portion of the fastening device 6 of the load carrier 9 can be recognized, i.e., two holding arms 7, which engage around at least a section of the roof rail 3 on both sides. This means that the holding arms 7 rest against the roof rail 3 on two respective opposing sides of the roof rail 3 (viewed in longitudinal direction). One of the holding arms 7 has the latching protrusion 8, which engages in the latching recess 9 through the passage 11 and thereby urges the cover 10 into the latching recess 9. Correspondingly the cover 10 no longer rests against the end stop 16 but is rather spaced apart from the same. Together with the cover 10 the pushrod 15 is also displaced, i.e., in the direction of an internal space 18 of the roof rail 3. This can be detected by an appropriate detection device, so that a cover state of the passage 11 can be detected. In this way it can be recognized whether a load carrier 4 is fastened in the roof rack 2.

The latching protrusion 8 interacts with a counter latching protrusion 19 of the roof rack 2 or the roof rail 3 for generating a rear grip connection. The counter latching protrusion 19 delimits at least regions of the latching recess 9. The rear grip connection prevents an unintended removal of the load carrier 4 from the roof rack 2 in vertical direction, i.e., in particular a displacement away from the vehicle roof 5. It can be seen that the cover 10 is fastened by being pressed into a holding recess 20 in the roof rack 2 or the roof rail 3. At least regions of the cover are configured elastic, in particular only a joint region 21, so that it is elastically pivotal between a closed position (FIG. 2) and an open position (FIG. 3). Insofar the cover 10 is configured as a flap and is supported so that at least a region of the cover is pivotal relative to the roof rack 2.

FIG. 4 shows a cross section through the roof rack 2 or the roof rail 3 in the region of the support recess 12, which extends between the latching recesses 9, which are arranged spaced apart from each other. Preferably further support recesses 12 are present on the side of each latching recess 9, which respectively face away from the respective other latching recess 9. Generally the support recess 12 has essentially the same cross section as the latching recess 9, i.e., viewed in cross section has almost the same inner contour. The only exception is a support element 22, which is arranged in a rear wall 23 of the support recess 12. This support element 22 is configured so that in the closed position of the cover 10 it rests against the cover 10 from the direction of the support recess 12. When during mounting of the load carrier 4 the fastening device 6 is arranged in the region of the support recess 12, the latching protrusion 8 cannot be urged into the support recess 12 so that correspondingly no rear grip connection can be generated between the latching protrusion 8 and the counter latching protrusion 19.

Thus an incorrect mounting of the load carrier 4, in particular mounting in an incorrect position on the roof rack 2, is effectively prevented. In particular the latching recesses 9 and the associated latching protrusions 8 are arranged so that the load carrier 4 can only be fastened on the roof rack 2 in the desired position relative to a longitudinal direction of the motor vehicle. For this purpose the latching recesses 9 have in longitudinal direction preferably the same or only slightly greater dimensions than the latching protrusions 8. Thus the mounting of the load carrier 4 on the roof rack 2 is only possible in the desired position in longitudinal direction. At the same time however by means of the here not shown detection device, which for example includes a magnet and a magnetic field sensor, a reliable detection of the covered state of the passage 11 is possible.

### LIST OF REFERENCE SIGNS

1 roof rack assembly
2 roof rack
3 roof rail
4 load carrier
5 vehicle roof 5
6 fastening device
7 holding arm
8 latching protrusion
9 latching recess
10 cover
11 through opening
12 support recess
13 rear wall
14 recess
15 push rod
16 end stop
17 fastening mounting
18 inner space
19 counter latching protrusion
20 holding recess
21 joint region
22 support element
23 rear wall

What is claimed is:

1.-10. (canceled)

11. A roof rack assembly for a motor vehicle, comprising:
a roof rack fastenable on a vehicle roof of the motor vehicle;
a load carrier fastenable on the roof rack, said load carrier having at least one fastening device which in a mounted state of the load carrier on the roof rack engages around at least a section of the roof rack on respective sides of the roof rack, said fastening device having a latching protrusion which in the mounted state of the load carrier engages through a passage into a latching recess of the roof rack;
a cover, constructed for closing the passage in a non mounted state of the load carrier; and
a detection device constructed for detection of a covered state of the passage by the cover.

12. The roof rack assembly of claim 1, wherein the cover is constructed as a flap and is supported pivotal on the roof rack.

13. The roof rack assembly of claim 1, wherein the detection device comprises at least one magnet and at least one magnetic field sensor.

14. The roof rack assembly of claim 13, wherein the magnet is fastened on the cover and the magnetic field sensor is fastened on the roof rack.

15. The roof rack assembly of claim 11, wherein in the mounted state of the load carrier, the cover is at least partially received in the latching recess.

16. The roof rack assembly of claim 11, wherein the cover and the passage extend at least over the latching recess and a support recess adjacent the latching recess, and wherein the cover rests against a support element in the support recess so as to be supported in the passage.

17. The roof rack assembly of claim 16, wherein the latching recess and the support recess are configured continuous.

18. The roof rack assembly of claim 16, wherein the cover is operatively connected with a pushrod in a region of the latching recess, said pushrod being guided through a recess in a rear wall of the latching recess into an internal space of the roof rack.

19. The roof rack assembly of claim 18, wherein the pushrod interacts with the detection device on a side of the pushrod, which faces away from the cover.

20. The roof rack assembly of claim 11, wherein the roof rack is an extruded section.
